(19) United States
(12) Patent Application Publication
(10) Pub. No.: US 2018/0112976 A1
(43) Pub. Date: Apr. 26, 2018

(54) MECHANICAL STRAIN EXTENSOMETER

(71) Applicant: SCK.CEN, Brussel (BE)

(72) Inventor: Pierre MARMY, Mol (BE)

(21) Appl. No.: 15/562,656

(22) PCT Filed: Mar. 28, 2016
(86) PCT No.: PCT/EP2016/056744

§ 371 Date: Sep. 28, 2017

(30) Foreign Application Priority Data
Mar. 31, 2015 (GB) 1505612.0

(51) Int. Cl. G01B 21/32; G01N 3/06

(52) U.S. Cl. CPC G01B 21/32; G01N 3/062

(57) ABSTRACT

A system for measuring mechanical strain comprises a main spring and a connecting piece both with an open concave cross-section, the connecting piece is rotatable mountable inside the main spring at a fixing point, such that the respective open concave cross-sections are in the same plane and the open parts are oriented in the same direction. The legs of the main spring are connectable with the specimen shoulders for applying the tips of the measuring arms onto the gauge length of the specimen. Measuring arms are rotatably mountable on the legs of the connecting piece so as to push against the specimen when mounted and so as to rotate when the measured object is subject to strain.

### FIELD OF THE INVENTION

The invention relates to the field of extensometers. More specifically it relates to systems for attaching extensometers to specimens whereby these specimens may be located in a hostile (e.g. high temperature, opaque, high pressure) environment.

### BACKGROUND OF THE INVENTION

In general, extensometers are used to measure deformation of a specimen on which an external force is exercised. Extensometers are typically used for stress-strain measurements and they give insight in the material properties of the specimen under test. These tests may be performed under varying test conditions such as for example in a liquid, under high pressure, under high temperatures, etc.

In extensometers the tips of the measuring arms are in contact with the gauge length of the specimen. Under influence of an axial force the specimen will become longer or shorter. This is sensed by the measuring arms which are pushed against the specimen and of which the tips will move closer to each other or of which the tips will move further apart from each other (U.S. Pat. No. 4,507,871 (A)). It is thereby important that the tips of the measuring arms maintain a good contact with the specimen. This good contact should be maintained when the specimen is elongated.

In prior art extensometers elongated rods are used (U.S. Pat. No. 4,884,456 (A)) when operation in a high temperature environment is required. These rods pass through openings in a furnace and their tips are pushed against the specimen under study. In these prior art extensometers the rods are elongated and the remaining part of the extensometer supporting the rods is moved outside the furnace further away from the specimen. The remaining part supporting the rods must guarantee a good contact between the rods and the specimen and must allow the rods to move under influence of an elongation or shortening of the specimen.

Extensometers have been developed for use in for example high temperature, high pressure environments. They are often installed in a plane orthogonal to the specimen axis and the strain transducer is also installed in that plane. There is however still room for improvement in these types of extensometers. Improvements can for example be realized in the sensitivity, in the ease of handling, in the robustness of the extensometers, in the resistance to the environment.

### SUMMARY OF THE INVENTION

It is an object of embodiments of the present invention to provide efficient systems for measuring the mechanical strain of a specimen, e.g. in harsh environments.

It is an advantage of embodiments of the present invention that systems for measuring the mechanical strain of a specimen in harsh environments can be provided, which provide trustworthy operation and are accurate.

The above objective is accomplished by a method and device according to the present invention.

The present invention relates to a system for measuring the mechanical strain along the gauge length of a longitudinal specimen, the system comprising
a main spring having an open concave cross-section, the main spring comprising two legs connectable to the specimen for holding the specimen and a part for interconnecting the legs,
a connecting piece having an open concave cross-section, the connecting piece being elastically rotatable mountable inside the main spring at a fixing point such that the connecting piece and the main spring have their open concave cross-section in the same plane and are oriented with their open sides in the same direction and such that the connecting piece can rotate with regard to the main spring, at the fixing point around an axis orthogonal to the plane of the open concave cross-section,
the system furthermore comprising a first measuring arm and a second measuring arm rotatably mountable on the connecting piece through a connecting tool, such that the first measuring arm and the second measuring arm push against the specimen when the specimen is held by the legs of the main spring, and such that the first measuring arm rotates with respect to the connecting piece when the specimen elongates or shortens.

It is an advantage of embodiments of the present invention that the force from the measuring arms on the specimen, in the longitudinal direction of the measuring arms, is equally distributed between both measuring arms. It is therefore an advantage of embodiments of the present invention that the grip of both measurement arms, as far as the force in the longitudinal direction is concerned, is the same for both measuring arms. When the specimen is elongated or shortened this grip will cause the measuring arms to rotate around their respective joints with the connecting piece. It is an advantage of embodiments of the present invention that strain of the specimen can be measured. It is an advantage of embodiments of the present invention that the measurement conditions, such as the distance between the two measuring arms, an equal force (in the elongated direction of the measuring arms) from both measuring arms on the specimen, are reproducible. It is an advantage of the present invention that the displacement between both measuring tips contact points may be unequally distributed at the transducers. It is an advantage of the present invention that the displacement between the contact points at the gauge length is always proportionally reproduced as the difference of displacement at the transducers. It is moreover an advantage of embodiments of the present invention that strain at high temperatures can be measured. In embodiments of the present invention temperature resistive materials such as ceramic materials are used for the parts which are exposed to high temperatures. It is an advantage of embodiments of the present invention that they can be applied in an opaque environment. It is an advantage of embodiments of the present invention that they can be used in a high density liquid environment. It is an advantage of embodiments of the present invention that they can be used in a corrosive liquid environment. It is an advantage of embodiments of the present invention that they can be used in a high pressure environment. In embodiments of the present invention the force of both measurement arms on the specimen is the same and is stable, also when used in a high density liquid environment, and in a high pressure environment.

One or both of the main spring or the connection piece may be substantially U-shaped or C-shaped.

The main spring may be a leaf spring.

The first measuring arm and the second measuring arm may be rotatably mountable to the legs of the connecting piece respectively in a first joint and a second joint and such that the first measuring arm rotates at the first joint and the second measuring arm rotates at the second joint when the specimen elongates or shortens.

The first leg of the main spring may comprise a first connecting tool and the second leg of the main spring may comprise a second connecting tool, such that the connecting tools are mountable to the specimen for holding the specimen.

It is an advantage of embodiments of the present invention that the system can be easily connected to the specimen. It is an advantage of embodiments of the present invention that the force with which the measuring arms push against the specimen can be regulated for example by adjusting hinge screws.

The first measuring arm may comprise a first ceramic tip. The second measuring arm may comprise a second ceramic tip such that the ceramic tips push against the specimen when mounted. It is an advantage of embodiments of the present invention that the ceramic tips which push against the specimen can be exposed to high temperatures. It is an advantage of embodiments of the present invention that the measuring arms end in a tip thereby providing a good contact with the specimen such that the tip does not slip when the specimen is elongated or shortened.

The first measurement arm may be resiliently mountable to the connecting piece by a first joint in between both and the second measurement arm may be resiliently mountable to the connecting piece by a second joint in between both. It is an advantage of embodiments of the present invention that the range over which the thickness of the specimen can vary is enlarged by having additional resilient joints between the connecting pieces and the measurement arms. It is an advantage of embodiments of the present inventions that over this enlarged range a good contact between the measurement arms and the specimen is provided. A good contact meaning that the measurement arm does not slip over the specimen when the specimen is elongated or shortened. It is an advantage of embodiments of the present invention that the first and second joint for mounting the measurement arms to the connecting piece facilitate the rotation of the measurement arms when the end of the measurement arms, touching the specimen, are moved caused by an elongation or shortening of the specimen.

The first leg of the connecting piece may have a different length than the second leg of the connecting piece, in order to allow the installation of measuring arms with different lengths. In this way, the vertical connecting rods can be side by side, with a minimal distance corresponding to the external diameter of one LVDT. Instead of LVDT, light sensors or other types of transducers could be installed having a different spacing. LVDT's are economic, stable over time and temperature fluctuations and reliable.

The first measuring arm and the second measuring arm may be connected with a transducer such that the position of the measuring arms can be measured using the transducer. It is an advantage of embodiments of the present invention that the distance over which the contact points (with the specimen) of the measurement arms are translated can be accurately and reproducibly measured using a transducer. It is an advantage of embodiments of the present invention that the extensometer is not rigidly fixed to any surrounding structure. Such a floating installation allows the measuring frame to be insensitive to thermal gradients or mechanical displacements of the gripping system.

It is an advantage of embodiments of the present invention that disturbing forces acting from the medium onto the measuring frame are not disturbing significantly the accuracy of the measurements.

The system may comprise a first tube and a second tube, wherein the first tube is connected between the first measuring arm and the transducer for transferring the movement of the first measuring arm towards the transducer, and wherein the second tube is connected between the second measuring arm and the transducer for transferring the movement of the second measuring arm towards the transducer. It is an advantage of embodiments of the present invention that the transducer can be moved away from the specimen to avoid a hostile environment for the transducer (e.g. in terms of temperature).

The transducer may be adapted for determining a movement of the first measuring arm or for determining a movement of the second measuring arm is positioned remote from the harsh environment.

It is an advantage of embodiments of the present invention that a local measurement of strain can be made in the hostile environment of a particle accelerator, allowing the specimen to be placed in the charged particle beam and the transducers a few cm away, where the dose rate is suitable for electromechanical components, such as LVDT transducers or strain gages sensors. Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 illustrates a 3D-drawing of an extensometer according to an embodiment of the present invention.

FIG. 2 illustrates a schematic drawing of an extensometer according to an embodiment of the present invention.

FIG. 3 illustrates a vertical cross-section of an extensometer according to an embodiment of the present invention.

FIGS. 4A and 4B illustrates top views of the extensometer according to embodiments of the present invention.

FIG. 5 illustrates a 3D-drawing of an extensometer comprising a transducer according to an embodiment of the present invention.

FIG. 6 shows a picture of an extensometer according to an embodiment of the present invention.

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Where in embodiments of the present invention reference is made to “the first end points” of the measurement arms, reference is made to the side of the measurement arms that push against the specimen when the extensometer is mounted on the specimen. The measurement points may be ceramic tips.

Where in embodiments of the present invention reference is made to “the second end points” of the measurement arms, reference is made to the end points opposite to the first measurement points.

Where in embodiments of the present invention reference is made to “a u-shaped piece”, reference is made to a piece that has a u-shaped cross section. The cross-section comprises two legs and a part interconnecting the two legs.

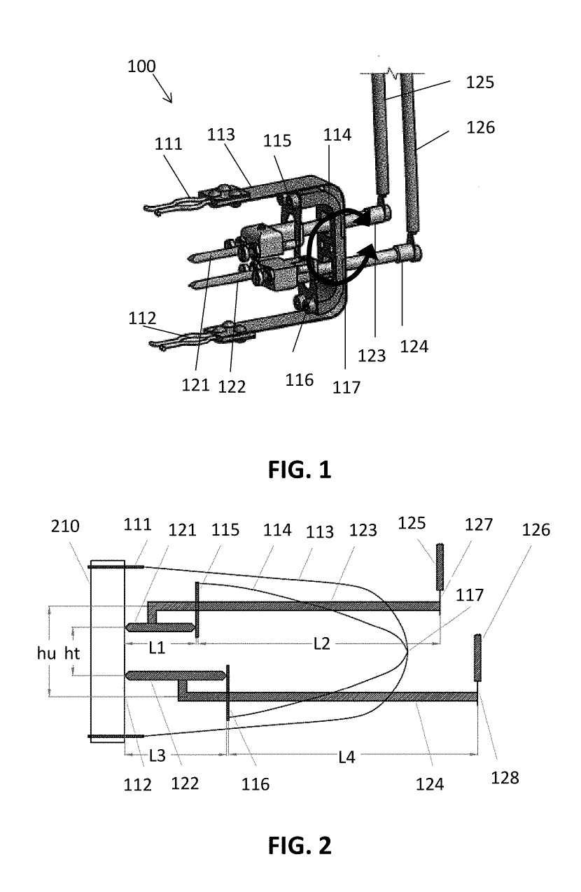

Embodiments of the present invention relate to systems 100 that are suitable for measuring the mechanical strain along the gauge length of a longitudinal specimen. By way of illustration, an exemplary embodiment is shown with reference to FIG. 1. The systems 100, also referred to as extensometers 100, are in embodiments of the present invention mounted on the specimen using a spring assembly. Embodiments of the present invention comprise a main spring 113 having an open concave cross-section, the main spring 113 comprising two legs connectable to the specimen for holding the specimen and a part for interconnecting the legs. The system also comprises a connecting piece 114 being very rigid, having an open concave cross-section, the connecting piece 114 being rotatable mountable inside the main spring 113 at a fixing point 117 such that the connecting piece 114 and the main spring 113 have their open concave cross-section in the same plane and are oriented with their open sides in the same direction. According to embodiments of the present invention, the connecting piece 114 can rotate by elastic deformation of the main spring 113 (with regard to the main spring 113) at the fixing point 117 around an axis orthogonal to the plane of the open concave cross-section.

The system furthermore comprises a first measuring arm 123 and a second measuring arm 124 rotatably mountable on the connecting piece 114 such that the first measuring arm 123 and the second measuring arm 124 push against the specimen when the specimen is held by the legs of the main spring, and such that the first measuring arm 123 rotates with respect to the connecting piece when the specimen elongates or shortens. In a particular example, the spring assembly comprises a main spring 113 with a u-shaped cross section. Nevertheless, the main spring also may have a C-shaped cross section or any other type of concave shape formed by legs for holding the specimen whereby the legs are interconnected. The connecting piece 114 may have a u-shaped cross section or c-shaped cross-section or any other type concave shape formed by legs for holding the sample whereby the legs are interconnected.

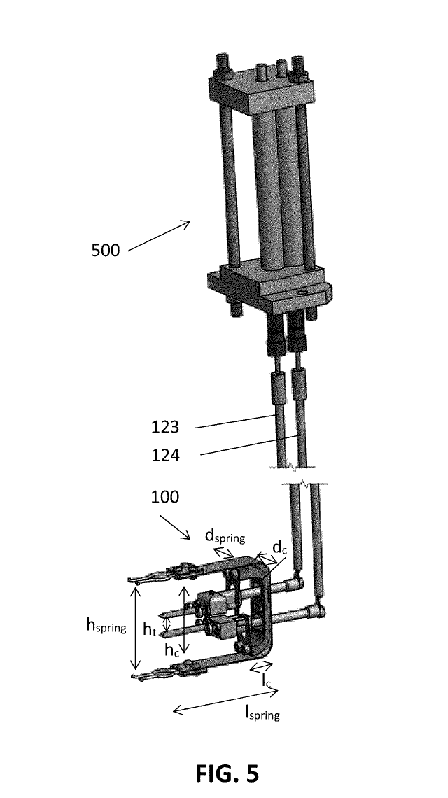

In embodiments of the present invention the main spring typically may be made of metal, like the high temperature alloys Nimonic 90 or A286. In embodiments of the present invention the length (l_{spring}) of the legs of the concave shaped spring, advantageously a leaf-spring, may in one example be between 20 and 60, preferably between 30 and 45 FIG. 5 shows an exemplary embodiment of the present invention wherein different dimensions are indicated. In embodiments of the present invention the distance (h_{spring}) between the legs of the concave, shaped spring, e.g. leaf-spring, may in one example be between 34 mm and 40 mm, preferably between 32 mm and 34 mm. In embodiments of the present invention the depth (d_{spring}), measured in the direction orthogonal to e.g. a u-shaped area, of an exemplary u-shaped leaf spring may be between 8 mm and 12 mm, preferably between 9.5 mm and 10.5 mm. In embodiments of the present invention the thickness of the main spring, e.g. a u-shaped leaf spring, may be between 0.35 mm and 0.5 mm, preferably between 0.39 mm and 0.41 mm.

In embodiments of the present invention the connecting piece 114 is a u-shaped or c-shaped piece as described above. In embodiments of the present invention the connecting piece is advantageously made of metal, although embodiments are not limited thereto, for instance 316L austenitic steels is a good choice for this application. In embodiments of the present invention the length (l_{c}) of the legs of the connecting piece may in one example be between 7 mm and 14 mm, preferably between 8 mm and 13 mm. In embodiments of the present invention the length of one leg of the connecting piece may be different from the length of the other leg. In embodiments of the present invention the distance (h_{c}) between the legs of the connecting piece may in one example be between 20 mm and 45 mm, preferably between 35 mm and 40 mm. In embodiments of the present invention the depth (d_{c}), measured in the direction orthogonal to the u-shaped area, of the connecting piece is between 8 mm and 12 mm, preferably between 9 mm and 11 mm. In embodiments of the present invention the thickness of the connecting piece may for example be between 2 mm and 4 mm, preferably between 2.5 mm and 2.8 mm.

In embodiments of the present invention the connecting piece 114 is attached to the main spring 113 in such a way that it can rotate elastically.

In embodiments of the present invention a protrusion at the fixing point 117 on the connecting piece 114 and/or on the main spring 113, between the connecting piece and the main spring 113 ensures a spacing between the remaining part of the bottom of the connecting piece and the main spring. In embodiments of the present invention the rotating movement is eased by this spacing.

When the system 100 is mounted on the specimen, the specimen is in the same plane as the u-shaped cross section of the main spring and of the connecting piece.

In embodiments of the present invention the legs of the main spring 113 are connectable with the specimen.

In an exemplary embodiment of the present invention the extensometer 100 comprises a first measuring arm 123 and a second measuring arm 124 which are mountable on the legs of the connecting piece 114. The first measuring arm 123 is mountable using a first joint 115 on one leg of the connecting piece 114. The second measuring arm 124 is mountable using a second joint 116 on the other leg of the connecting piece 114. When mounted, the legs can rotate at the joints, around an axis which is orthogonal to the plane of the u-shaped cross-section of the connecting piece 114. In embodiments of the present invention the distance (hₜ) between the measuring arms may for example range between 5 mm and 12 mm, preferably between 5 mm and 10 mm.

When the measuring arms 123 are mounted and when the legs of the main spring are connected with the specimen, the first measuring arm 123 and the second measuring arm 124 push against the specimen. In embodiments of the present invention the measuring arms are substantially orthogonal to the longitudinal direction of the specimen. The angle between the measuring arms and the specimen axis may for example be between 82° and 98°, preferably between 89° and 91°, preferably 90°. The angle will depend on the application, be around 90° for fatigue specimens, up to the limits indicated for tensile and fracture toughness. The end points with which they push against the specimen are referred to as the first end points. In embodiments of the present invention the measuring arms comprise ceramic tips 121, 121. In these embodiments the first end points are the ceramic tips which push against the specimen and are thus the first end points of the measuring arms. In order to increase the grip on the specimen the first end points may have a knife edge. The angle of the edge of the ceramic tip impacting on the specimen may range between 55° and 65°, preferably between 59° and 61°.

In embodiments of the present invention the first end points transmit the displacement sensed onto the gauge length of the specimen.

In embodiments of the present invention the connecting piece 114 acts as a balance with as tipping point the fixing point 117. A force change on one of the measuring arms 123, 124, in the longitudinal direction of the measuring arms, will cause the connecting piece to rotate until the forces on the measuring arms are equal again. It is therefore an advantage that the force of the specimen against the measuring arms, in the longitudinal direction of these measuring arms, is the same for these measuring arms. It is an advantage of embodiments of the present invention that no additional operations are required to have an equal force of the specimen onto the measuring arms in the longitudinal direction of these measuring arms. Even if the thickness of the specimen differs along the longitudinal length of the specimen, the force on both arms is the same. The grip of the first end points of the measuring arms 123, 124 against the specimen is, as far as the longitudinal force is concerned, therefore the same for both measurement arms. When, during a mechanical strain measurement test with an extensometer according to the present invention, the specimen is elongated or shortened, it is this grip that will cause the first end points of the measuring arms 123, 124 to move in the elongation or shortening direction. In embodiments of the present invention this movement will cause the measuring arms to rotate around the point where the measuring arm is mounted to the leg of the connecting piece 114. In embodiments of the present invention the measuring arms 123, 124 may be mounted using a joint. In embodiments of the present invention the joint may be a leaf spring 115, 116 made of metal. Two tiny holes of 0.5 mm may be drilled into the leaf spring 115, 116. The measuring arms 123, 124 may be equipped with adjustable screws. The tip of the screws may be conical for example with a tip angle of 60°. The tip of the screws may be pushing against the leaf spring at the holes. For the purpose of low friction, the holes advantageously should have a diameter between for example 0.4 mm and 0.5 mm. When rotating, the second end points of the measuring arms will move in the opposite direction.

In embodiments of the present invention these ends will drive directly or indirectly one or two transducers. The effective translation can be measured using this transducer. In the case the transducer is a U-shaped strain gage transducer, it can be installed directly in the plane orthogonal to the specimen, at the end of the connecting parts 123, 124. In this case the arms 123, 124 have the same length and the connecting part 114 is symmetrical.

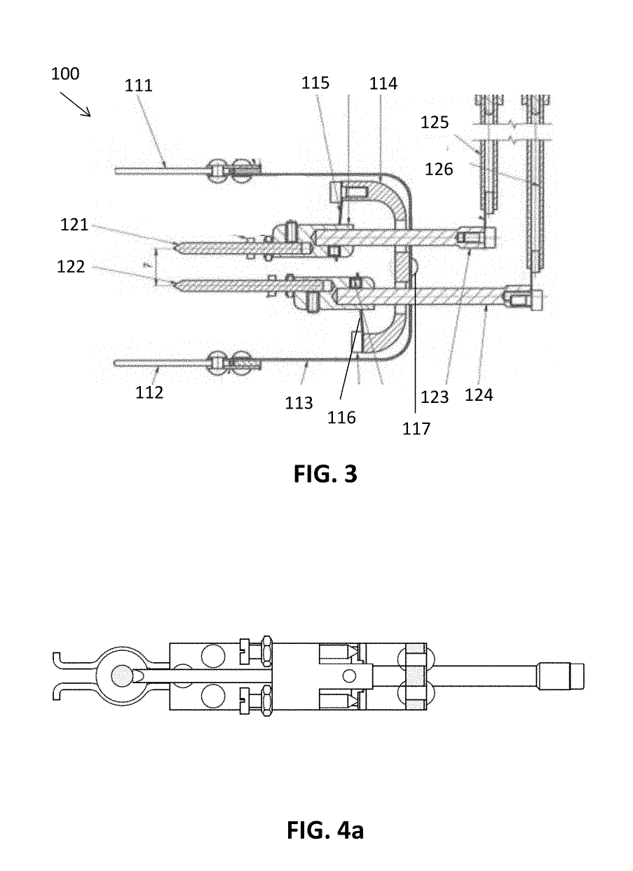

In an exemplary embodiment of the present invention, the second end points are driving the transducer indirectly. An example thereof is illustrated in FIG. 3 and FIG. 5. In this example, the displacements of the measuring arms 123, 124, are transmitted vertically via a first and a second tube 125, 126 to a transducer 500, such as a linear variable differential transformer (LVDT) or equivalent device. In these devices the linear displacement is typically converted into an electrical signal. Therefore different coils are positioned in a transformer setup and the displacement of the tube causes a change in currents through the coils.

The first and second tube may be made of ceramic material or any material having a low thermal elongation coefficient and a low density. The first and second tube may be connected to the measuring arms using a sheet metal joint 127, 128. The sheet metal joint is critical in the design to allow for a frictionless and rigid connection between the tubes and the arms. The sheet metal joint if fabricated from a stainless steel foil having a thickness between 80 and 100 microns. The first and second tube 125, 126 enlarge the distance between the specimen and the transducer. Thus the transducer can be shielded from the environment in which the specimen resides, protecting the transducer 500 from this environment (e.g. from heat).

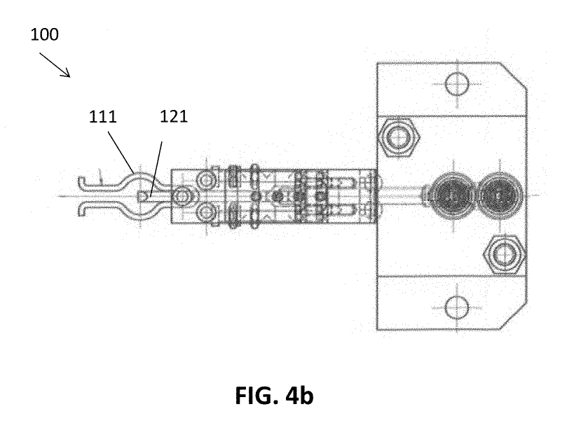

In embodiments of the present invention the first leg of the main spring 113 comprises a first connecting tool 111 and the second leg of the main spring 113 comprises a second connecting tool 112. These connecting tools can be connected to the specimen allowing to mount the main spring 113 to the specimen. In embodiments of the present invention such a connecting tool may be a connection spring which can snap around a cylindrical groove machined on the specimen by pushing it against the specimen. An example of a connection spring 111 is shown in FIG. 4. In the embodiments of the present invention, the connection spring 111 has its ends formed as a hook in order to install a fine metallic wire to bind the two ends of the spring 111. Eventually the wire is installed to increase the closing force of the spring. This may be useful in some special cases. Other types of connecting tools are suitable for this application, providing they will prevent any movement of the frame in a direction orthogonal to the specimen axis.

In embodiments of the present invention the force of the measuring arms on the specimen, in the longitudinal direction of the measuring arms, ranges between 50 and 250 g, preferably between 150 and 200 g.

The regulating screws installed on the arms 123, 124 and pushing against the connecting tools 111, 112 may be arranged such that the force of the measuring arms 123, 124 on the specimen, in the longitudinal direction of the measuring arms, can be adjusted.

In embodiments of the present invention the first measurement arm 123 is resiliently mountable to the connecting piece by a first joint 115 in between both, and the second measurement arm 116 is resiliently mountable to the connecting piece by a second joint 116 in between both. The joints 115, 116 may be leaf springs. They allow to maintain a pressure, between the measurement arms and the specimen, over a larger distance range of the specimen. The leaf springs 115, 116 are best manufactured with heat resisting materials like the high temperature alloys Nimonic 90 or A286. The thickness of the leaf spring can in one example be between 0.18 mm and 0.22 mm, best 0.2 mm.

FIG. 2 shows a schematic drawing of an embodiment in accordance with the present invention. The figure shows a u-shaped main spring 113. On the inside of the main spring, a u-shaped connecting piece is mounted. Both u-shaped cross sections are in the same plane and they are oriented in the same direction. The main spring and the connecting piece are connected at the fixing point 117 which is located on the opposite side of the opening of the u-shaped spring 113. The connecting piece 114 is mounted on the main spring 113 such that it can rotate elastically with respect to the main spring. The rotation axis is thereby orthogonal to the u-shape area. FIG. 2 also shows a first connecting tool 111 and a second connecting tool 112 which are fixed to the legs of the main spring. These connecting tools 111, 112 allow mounting (e.g. by clicking) the system 100 on the specimen 210. FIG. 2 also shows a first measuring arm 123 and a second measuring arm 124 mounted to the legs of the connecting piece 114 using a first joint 115 and a second joint 116. The joints may be metal joints. FIG. 2 also shows that the measuring arms comprise ceramic tips 121, 122. These ceramic tips push against the specimen 210 when the system 100 is mounted onto the specimen. If the specimen 200 is elongated or shortened the ceramic tips 121, 122 are moved causing the measuring arms 123, 124 to rotate around the metal joints 115, 116. The position of the joints 115, 116 along the length of the measuring arms may be designed depending on the grip of the specimen on the measurement arms.

FIG. 1 shows a 3D-graph of an exemplary embodiment in accordance with the present invention. It shows the same features as in FIG. 2. The connecting tools 111, 112 are connecting springs and they can be clicked on the specimen. Depending on the size of the specimen, they can be replaced with different sized connecting tools. The measuring arms 123, 124 comprise ceramic tips 121, 122. These ceramic tips can be replaced when outworn or when required because of the size of the specimen. The also may be replaced with tips made of another material. In FIG. 1 the first end of the measuring arms 123, 124 push against the specimen. In the embodiment of FIG. 1 these first ends are the ceramic tips 121, 122. The opposite second ends are connected the first and second tube 125, 126 respectively. The connection to the frame is made using metal joints 115, 116, which are frictionless hinges. In the embodiment of FIG. 1 measuring arms 123, 124 are positioned horizontally and the first and second tubes 125, 126 are positioned vertically. The first and second tubes 125, 126 may be made of ceramic material. On the opposite sides the first and second tubes are connected to a transducer 500. This is shown in FIG. 5.

FIG. 3 shows a technical drawing of a system 100 in accordance with embodiments of the present invention. FIGS. 4a and 4b show the top view of the same system 100. In the exemplary embodiment of FIG. 3 the main spring 113 has a u-shaped profile. A first and a second connecting tool 111, 112, for connecting the system 100 to the specimen are connected to the legs of the main spring 113. A u-shaped connecting piece 114 is mounted inside the main spring 113. The bottom side, i.e. the side connecting the legs of the connecting piece 114 is fixed to the bottom side of the main spring at the fixing point 117. In embodiments of the present invention the fixing point 117 is located in the middle of the bottom sides. The u-shaped cross-sections of the main spring and of the connecting piece are oriented in the same direction when mounted. The first measuring arm 123 is connected with one leg of the connecting piece 114 using a first joint 115. In the embodiment illustrated in FIG. 3 the first joint is a sheet metal joint. The second measuring arm 124 is connected with the other leg of the connecting piece 114 using a second joint 116. In the embodiment illustrated in FIG. 3 the second joint is a sheet metal joint. The first measuring arm 123 comprises a first ceramic tip 121. The second measuring arm 124 comprises a second ceramic tip 122. The measuring arms 123, 124 are oriented in the direction of the legs of the connecting piece. The ceramic tips 121, 122 are oriented in the same direction and are positioned at the open side of the u-shaped form of the connecting piece. The ceramic tips are positioned such that they push against the specimen when the system is mounted on the specimen. The ceramic tips are the first ends of the measuring arms. The opposite ends of the measuring arms are connected to the first tube 125 and the second tube 126 respectively. In the exemplary embodiment of the present invention, illustrated in FIG. 3, the measuring arms 123, 124 are oriented horizontally and the tubes 125, 126 are oriented vertically. An elongation or shortening of the specimen causes a displacement of the first ends of the measuring arms, causing the measurement arms to rotate and causing a displacement of the opposite ends. These ends move the first tube 125 and the second tube 126. The distance ahead of the joint 115, 116 and behind them should have the same ratio for the bottom and top arm: 11/12=13/14, as shown in the sketch of FIG. 2. The tubes may be connected to a transducer 500. A cross section of the system 100, showing a top view of the arm 124, illustrated in FIG. 3, is shown in FIG. 4. The first connecting tool 111 which is a connection spring that can be clicked on the specimen is shown in the figure. Also the first ceramic tip 121, which will push against the specimen when the system 100 is mounted on the specimen is shown in the top view figure.

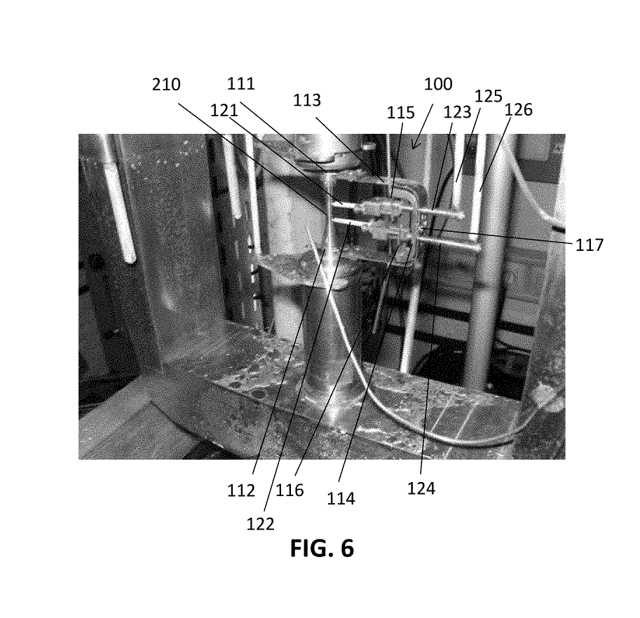

FIG. 6 shows a picture of an exemplary embodiment of the present invention. The extensometer 100 is mounted on an elongated specimen 210 by means of the first connecting tool 111 and the second connecting tool 112 which are fixed to the legs of the u-shaped main spring 113. On the inside of the u-shaped main spring 113 a u-shaped connecting piece is rotationally mounted such that the u-shaped cross-sections of the main spring and of the connecting tool are both in the same plane. Both u-shapes oriented with their open side in the same direction and connected with the closed side against each other at the fixing point 117. The connecting piece 114 can elastically rotate around the fixing point 117 with the rotation axis orthogonal to the u-shaped area. A first measuring arm 123 and a second measuring arm 124 are fixed to the first leg and to the second leg of the connecting piece 114 using a first metal joint 115 and a second metal joint 116. In the exemplary embodiment of which the picture is shown in FIG. 6 the specimen is oriented vertically and the u-shaped areas of the connecting piece 114 and of the main spring 113 are also oriented vertically. The legs of the u-shaped main spring 113 and the legs of the u-shaped connecting piece 114, as well as the first measuring arm 123 and the second measuring arm 124 are oriented horizontally. One leg of the connecting piece is shorter than the other leg of the connecting piece 114. The measuring arms are elongated pieces which push with their first end against the specimen when the extensometer is mounted on the specimen. The first ends of the measuring arms 123, 124 are the first and second ceramic tip 121, 122 respectively. In FIG. 6 these ceramic tips are oriented horizontally and they push against the vertically oriented specimen. The ceramic tips can be replaced and they have a sharpened edge pushing against the specimen. They can be made of 2 mm plain ceramic rod. Opposite to the first ends of the measuring arms are the second ends of the measuring arms. These ends can be fabricated from a temperature resisting and low density material, like ceramic. In the present embodiment of the invention, they are fabricated from titanium alloy. These ends can be connected to one end of vertically oriented tubes 125, 126 using connecting tools 127, 128 The connecting tools 127, 128 are made of 0.1 mm stainless steel sheet. The vertically oriented tubes are, in the embodiment of FIG. 6, made of ceramic material with tubular cross section. The other ends of the tubes may be connected though a frictionless joint to a transducer for measuring their displacement caused by an elongation or shortening of the specimen.

In order to maximize the dynamic properties of the extensometer, it is an advantage to manufacture all moving parts of the extensometer 100 from low density materials.

1.-11. (canceled)

12. A system for measuring the mechanical strain along the gauge length of a longitudinal specimen, the system comprising
a main spring having an open concave cross-section, the main spring comprising two legs connectable to the specimen for holding the specimen and a part for interconnecting the legs,
a connecting piece having an open concave cross-section, the connecting piece being elastically rotatable mountable inside the main spring at a fixing point such that the connecting piece and the main spring have their open concave cross-section in the same plane and are oriented with their open sides in the same direction and such that the connecting piece can rotate with regard to the main spring, at the fixing point around an axis orthogonal to the plane of the open concave cross-section,
the system furthermore comprising a first measuring arm and a second measuring arm rotatably mountable on the connecting piece through a connecting tool, such that the first measuring arm and the second measuring arm push against the specimen when the specimen is held by the legs of the main spring, and such that the first measuring arm rotates with respect to the connecting piece when the specimen elongates or shortens.

13. A system according to claim 12, wherein one or both of the main spring or the connection piece are substantially U-shaped or C-shaped.

14. A system according to claim 12, wherein the main spring is a leaf spring.

15. A system according to claim 12, wherein the first measuring arm and the second measuring arm are rotatably mountable to the legs of the connecting piece respectively in a first joint and a second joint and such that the first measuring arm rotates at the first joint and the second measuring arm rotates at the second joint when the specimen elongates or shortens.

16. A system according to claim 12, wherein the first leg of the main spring comprises a first connecting tool, and wherein the second leg of the main spring comprises a second connecting tool, such that the connecting tools are mountable to the specimen for holding the specimen.

17. A system according to claim 12, wherein the first measuring arm comprises a first ceramic tip, and wherein the second measuring arm comprises a second ceramic tip such that the ceramic tips push against the specimen when mounted.

18. A system according to claim 12, wherein the first measurement arm is resiliently mountable to the connecting piece by a first joint in between both, and wherein the second measurement arm is resiliently mountable to the connecting piece by a second joint in between both.

19. A system according to claim 12, wherein the first leg of the connecting piece has a different length than the second leg of the connecting piece, in order to allow the installation of measuring arms with different lengths.

20. A system according to claim 12, wherein the first measuring arm and the second measuring arm are connected with a transducer such that the position of the measuring arms can be measured using the transducer.

21. A system according to claim 12, wherein the system comprises a first tube and a second tube, wherein the first tube is connected between the first measuring arm and the transducer for transferring the movement of the first measuring arm towards the transducer, and wherein the second tube is connected between the second measuring arm and the transducer for transferring the movement of the second measuring arm towards the transducer.

22. A system according to claim 21, wherein the transducer for determining a movement of the first measuring arm or for determining a movement of the second measuring arm is positioned remote from the harsh environment.
